(19) United States
(12) Patent Application Publication
(10) Pub. No.: US 2024/0361139 A1
(43) Pub. Date: Oct. 31, 2024

(54) SYSTEMS AND METHODS FOR ORCHESTRATING EXTERNAL SERVICES FROM A NAVIGATION SYSTEM

(71) Applicant: Google LLC, Mountain View, CA (US)

(72) Inventor: Matthew Sharifi, Kilchberg (CH)

(21) Appl. No.: 18/029,830

(22) PCT Filed: Aug. 30, 2022
(86) PCT No.: PCT/US2022/042039

§ 371 Date: Mar. 31, 2023

(51) Int. Cl. G01C 21/34; G01C 21/36; G06Q 50/40; H04L 9/40

(52) U.S. Cl. CPC G01C 21/3476; G01C 21/3697; G06Q 50/40; H04L 63/0861

(57) ABSTRACT

The present disclosure provides computer-implemented methods, systems, and devices for integrating external services into a navigation system. A computing device receives, from a user computing system associated with a user, a navigation request, the navigation request including a destination. The computing device generates, based on geographic data stored in a database, a suggested route to the destination, wherein the suggested route includes an interaction with a system other than the navigation system. The computing device transmits, to the user computing system, route recommendation data for display at the user computing system, the route recommendation including a recommendation to perform the interaction with the system other than the navigation system. The computing device, in response to receiving an approval indication from the user computing system, transmits initiation data to the system other than the navigation system to initiate the interaction.

The present disclosure relates generally to computer-based navigation. More particularly, the present disclosure relates to accessing services from systems other than the navigation system from within a navigation system.

### BACKGROUND

As computer technology has improved, the number and type of services that can be provided to users have increased dramatically. The services provided via computer technology include navigation services. A navigation service can allow a user to navigate from a current position to a destination position. The user can submit a destination (e.g., an address) through an application associated with a navigation service. The navigation service can, using map data for a geographic area, generate a planned route to the destination. In some examples, the planned route includes one or more turn-by-turn navigation directions.

### SUMMARY

Aspects and advantages of embodiments of the present disclosure will be set forth in part in the following description, or can be learned from the description, or can be learned through practice of the embodiments.

An example aspect is directed towards a computer-implemented method. The method comprises receiving, by a computing system with one or more processors from a user computing system associated with a user, a navigation request, the navigation request including a destination. The method further comprises generating, by the computer system based on geographic data stored in a database, a suggested route to the destination, wherein the suggested route includes an interaction with a system other than the navigation system. The method further comprises transmitting, by the computing system to the user computing system, route recommendation data for display at the user computing system, the route recommendation including a recommendation to perform the interaction with the system other than the navigation system. The method further comprises, in response to receiving an approval indication from the user computing system, transmitting, by the computing system, initiation data to the system other than the navigation system to initiate the interaction.

Another example aspect of the present disclosure is directed to a computing device. The wearable computing device comprises one or more processors; and a computer-readable memory. The computer-readable memory stores instructions that, when executed by the one or more processors cause the computing device to receive, from a user computing system associated with a user, a navigation request, the navigation request including a destination. The instructions further cause the one or more processors to generate, based on geographic data stored in a database, a suggested route to the destination, wherein the suggested route includes an interaction with a system other than the navigation system. The instructions further cause the one or more processors to transmit, to the user computing system, route recommendation data for display at the user computing system, the route recommendation including a recommendation to perform the interaction with the system other than the navigation system. The instructions further cause the one or more processors to, in response to receiving an approval indication from the user computing system, transmit initiation data to the system other than the navigation system to initiate the interaction.

Another example aspect of the present disclosure is directed towards a computer-readable medium storing instructions. The instructions, when executed by one or more computing devices, cause the one or more processors to receive, from a user computing system associated with a user, a navigation request, the navigation request including a destination. The instructions further cause the one or more processors to generate, based on geographic data stored in a database, a suggested route to the destination, wherein the suggested route includes an interaction with a system other than the navigation system. The instructions further cause the one or more processors to transmit, to the user computing system, route recommendation data for display at the user computing system, the route recommendation including a recommendation to perform the interaction with the system other than the navigation system. The instructions further cause the one or more processors to, in response to receiving an approval indication from the user computing system, transmit initiation data to the system other than the navigation system to initiate the interaction.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing system according to example embodiments of the present disclosure;

FIG. 2 depicts an example client-server environment according to example embodiments of the present disclosure;

FIG. 3 illustrates an example navigation system in accordance with example embodiments of the present disclosure;

FIG. 4 depicts an example user interface according to example embodiments of the present disclosure; and

FIG. 5 depicts an example flow diagram for a method for improving a navigation application by incorporating the ability for routes to include interactions with a system other than the navigation system from within the navigation application in accordance with example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed towards a system for improving a navigation application by integrating travel services external to the navigation system into the navigation system itself. For example, a user may, via a user computing device, request navigation data for a specific destination. In some examples, the navigation system can generate a route for the user including interacting with one or more services provided by systems external to the navigation system. For example, the navigation system can generate a recommended route that includes a segment of the route which is planned to be traveled on public transportation. The navigation system can provide a recommendation to the user to interact with a computing system associated with a public transportation system to complete at least one segment of the recommended route. In response to a user accepting the recommendation, the navigation system can transmit initiation data to initiate an interaction with a computer system external to the navigation system to enable the user to access the public transportation without needing to leave the navigation application through which the navigation request is transmitted.

For example, if a user submits a navigation request for a navigation route from the user's current location to a location in the downtown of a city, the navigation system can generate a route that directs the user to walk to the entrance of the local public transportation system and use a public transportation system to travel to the destination. The navigation system can transmit a prompt requesting the user to confirm the use of the public transportation system for the segment of the route for which it is recommended. The navigation system can receive user feedback indicating the user approves of accessing the public transportation system for the segment for which it is recommended. In response, the navigation system can transmit initiation data (including transaction data) to facilitate the purchase of an appropriate ticket on the public transportation system. For example, the public transportation system can have an API that allows external services to automatically purchase tickets for travel using the public transportation system. The navigation system can then provide the ticketing information to the user for display in the navigation system.

More generally, a computing device can include a navigation system. A navigation system can be enabled by a server computing system. A server computing system can be any computing system configured to communicate with a user computing device (or other computing devices) over a network to provide information or a service.

A user computing device can be any computing device that is designed to be operated by an end-user. For example, a user computing device can include, but is not limited to, a personal computer, a smartphone, a smartwatch, a fitness band, a tablet computer, a laptop computer, a navigation computing device, a wearable computing device, and so on. In some examples, a user computing device can include one or more sensors intended to gather information, with the permission of the user, such as location information.

A navigation application can be any application on a user computing device configured to provide navigation information to a user upon request based on communication with the navigation system. For example, a navigation application can provide turn-by-turn directions from a starting location to an ending location.

The navigation application can receive a navigation request based on input from a user. In response to receiving the navigation request, the navigation application can transmit the navigation request to the navigation system. In some examples, the navigation request can include a destination. The navigation request can also include an origination point. The origination point can be the current location of the user computing device as determined by one or more sensors available to the user computing device. The navigation request can include additional information such as a proposed means of transportation, any relevant time-based constraints (e.g., an arrival time or a departure time), and any user preferences.

The navigation system can generate a route from the origination point to the destination. In some examples, the navigation system can include a plurality of segments. In some examples, each segment can be associated with one or more interactions with a system other than the navigation system. In some examples, the system other than the navigation system is an third-party system provided by a third-party (e.g., a company other than the company that provides the navigation system.) If so, the navigation system can communicate with the third-party system via normal communication over the Internet or other computing network. Alternatively, the system other than the navigation system can be a system external to the navigation system but one that has the same parent company. For example, a particular entity (e.g., a corporation) can provide a navigation system in addition to other services. If the services are not integrated into the navigation system, the navigation system can access them via a communication network or via a communication channel internal to the parent company but external to the navigation system).

The interactions can include, but are not limited to: paying for a ticket to a public transportation system, ordering a taxi or ride-sharing vehicle to perform a segment of the planned route, paying for parking at the end of the route, and paying for entrance to a location such as a museum, a theme park, or a zoo. In some examples, for interactions that include purchasing tickets (e.g., for public transportation or for access to a location), the navigation system can prompt the user to provide the number of tickets needed (e.g., if a group of users is traveling together, they may require more than one ticket). Similarly, the navigation system can prompt the user for a ticket type (e.g., senior ticket, child ticket, etc.) for each ticket.

In some examples, the navigation request can include a list of applications installed on the user computing device if the user approves transmitting such information. In some examples, the navigation system may only consider performing interactions that are available to the navigation system. For example, the navigation system may be able to perform interactions without the need for user interactions if the interaction is available via an API or through using one or more applications installed on the user computing device. In other examples, the navigation system can perform some aspects of the interaction and enable the user to perform others. For example, the navigation system can initiate a telephone call to the appropriate system and allow the user to communicate with the system via communications. Similarly, the navigation system can communicate with a system other than the navigation system via SMS message, chat messages, texts, or any other communication methods.

In some examples, the navigation system can consider a plurality of potential routes, each interacting with a different action or service outside of the navigation system. These candidate routes can be ranked based on the likelihood that the user will approve of performing the interaction associated with the system other than the navigation system (e.g., an external system). For example, the navigation system can prioritize candidate routes that include an interaction with a public transportation system if the system determines that the user prefers to travel using the public transportation system. The user's preferences can be determined based on whether an application associated with a local public transport system is installed (or otherwise accessible) on the user computing device. In addition, the user's preferences can be determined based on whether the user has indicated, either directly, or through previous interactions made available to the navigation system by the user, that the user prefers to use the public transport system. Similarly, a user account can include user preference data describing the user's preferred transport methods.

The navigation system can transmit data associated with a recommended route to the user computing device for display. If the route includes an interaction with a system other than the navigation system, the transmitted route can include instructions to display a prompt to the user. The prompt can request that the user approve the recommended interaction with the system other than the navigation system. For example, “Do you approve of using a taxi to go from Point A to Point B?” The user can, through interaction with the navigation application on their user computer device, accept or reject the suggestion. If the user accepts the interaction, the user computing device can transmit acceptance data to the navigation system.

In some examples, the navigation system can receive the user acceptance data. In response to receiving user acceptance data, the navigation system can initiate an interaction with a system other than the navigation system. In some examples, the navigation system can determine a time associated with initiating the interaction. For example, if the suggested route includes a walking portion, followed by a taxi ride portion, followed by a second walking portion, the navigation system can estimate the time at which the taxi portion of the route will begin. Based on the estimation, the navigation system can initiate the reservation of a taxi service based on the estimated time at which the first walking portion will be completed. In some examples, the user computing device can transmit an updated device location to the navigation system as the user begins to travel the route.

Based on this travel information, the navigation system can generate an estimated time of arrival for the user at the end of the first walking segment. This estimated time can be used, in combination with the starting location for the taxi segment of the route, to reserve the taxi service. In some examples, if the navigation system determines that the user has been delayed (based on location information from the user computing device), the navigation system can update the booked interaction. Similarly, if the navigation system has reserved a parking spot or a specific time for attending a location, the navigation system can update the reserved time or the specific time of attendance based on the updated location of the user computing device.

In some examples, the navigation system initiates the interaction by transmitting initiation data to the system other than the navigation system via an API. For example, some computing systems associated with actions the navigation system may wish to employ can provide an outward-facing API that allows computer systems to automatically initiate interactions by transmitting correctly formatted data to the system other than the navigation system. In other examples, if no such API is available, the navigation computing system can transmit data to the user computing device, with the user's permission, that interacts with applications on the user computing device to initiate interactions. For example, interaction data can include data that causes the application associated with a particular action to perform that particular action. For example, the interaction data can include data for controlling the user computing device such that it can perform input on the selected application to achieve the desired result.

In some examples, before such an interaction can be initiated, the navigation system can request that the user authenticate themselves via passcode or voice authentication. In this way, the navigation system can ensure that only the user associated with one or more accounts can initiate services associated with those accounts and/or conduct transactions for those services through the user's accounts. In some examples, the navigation application on the user computing device can be used in a hands-free manner. If so, the navigation application can provide information (e.g., including recommendations, route instructions, and so on). In some examples, the user can be operating their user computing device in a hands-free manner and can audibly confirm the interaction (or transaction). The recorded audio can be transmitted to the navigation system where it can be compared to predetermined voice print information. If the audio data matches, the navigation system can determine that the user has approved of the interaction.

In some examples, the user can instruct the navigation system such that interactions with a particular system other than the navigation system can be performed when included in a route without the need for explicit user approval for each interaction. Thus, if a recommended route includes an interaction with a pre-approved system other than the navigation system, the navigation system can automatically perform the interaction if the user approves the recommended route generally (e.g., begins using the recommended route to navigate).

In some examples, if the interaction is successful, the navigation system can transmit confirmation information to the user computing device for display to the user. For example, visual or audio information can be displayed to the user once the action has been successfully initiated. In one particular example, an audio notification can be played over the audio speakers of the user computing device indicating that a toll has been paid for a particular segment of the user route.

The systems and methods of the present disclosure provide a number of technical effects and benefits. As one example, the proposed systems can provide for automatically recommending an interaction with a system other than the navigation system and, if the user accepts, automatically initiating the interaction without the need for users to access another application or service. Automatically accessing data about an external service (e.g., a service provided by a system other than the navigation system), recommending the use of the external service to a user, and automatically initiating the external service enables a navigation application to provide more efficient navigation services to a user. Improving the effectiveness of navigation applications can reduce the amount of storage needed and energy used when providing navigation information. Reducing the amount of storage needed and energy used reduces the cost of the navigation service associated with the navigation application, improves the user experience, and extends useful battery life. This represents an improvement in the functioning of the device itself. This has a technical benefit of avoiding the necessity to reserve resources such as processor, memory, and other operating system overheads as well as associated network usage on either the navigation system or the user device in order to invoke a (third party) application to allow interaction with that application. This results in the more efficient operation of the navigation system and the user device as both are free to carry out other operations with the saved resources rather than invoking the external application.

With reference now to the Figures, example embodiments of the present disclosure will be discussed in further detail.

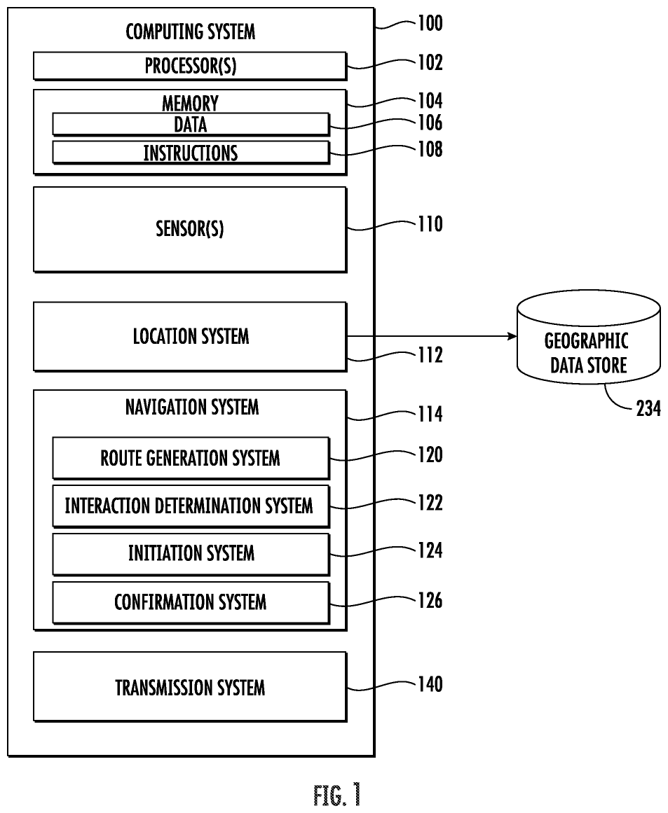

FIG. 1 depicts an example computing system 100 according to example embodiments of the present disclosure. In some example embodiments, the computing system 100 can be any suitable device, including, but not limited to, a desktop computer, a server computing system, or any other computing device that is configured such that it can allow a person to execute a navigation system. The computing system 100 can include one or more processor(s) 102, memory 104, an application programmatic interface 130, a location system 112, a navigation system 114, and a transmission system 140.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store data 106 accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the application programmatic interface 130, the location system 112, the navigation system 114, and the transmission system 140. Thus, the computing system 100 can implement the application programmatic interface 130, the location system 112, the navigation system 114, and the transmission system 140 to execute aspects of the present disclosure, including receiving a navigation request from a user, generating a recommended route that includes interactions with one or more systems other than the navigation system, transmitting the recommended route to the user computing device including a prompt to perform an interaction with a system other than the navigation system, receiving the user's approval to perform the interaction, and transmitting initiation data to a system other than the navigation system to initiation the interaction.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as geographic data associated with the navigation system 114 (e.g., data representing a geographic area including one or more roads, one or more locations of interest, and one or more systems other than the navigation system) that can be retrieved, manipulated, created, or stored by the one or more processor(s) 102. In some example embodiments, such data can be accessed, displayed, or transmitted as needed.

In some example embodiments, the computing system 100 includes an application programmatic interface 130, a location system 112, a navigation system 114, and a transmission system 140. The application programmatic interface 130 (API) can be a software interface that allows users or computer programs to interact with the service over a network. The API 130 has an associated specification that describes the standard way to interact with the API 130 to achieve a desired result offered by the service for which the API 130 is associated. In this example, the API 130 serves to act as an interface between one or more user computing devices and the computing system 100 as well as an interface between one or more systems other than the navigation system (e.g., transportation providers systems, ticketing systems, and so on) and the computing system 100.

One or more entities can, using a computing system that communicates to the API 130 over a computing network, access and interact with this API 130 to provide information from and receive information from the computing system 100. In some examples, the APIs 130 can store any data associated with interacting with a system other than the navigation system.

In some examples, the location system 112 can be used by the computing system 100 to determine the location of one or more user computing devices. For example, user computing devices can provide information to the computing system 100 that can allow the computing system 100 to determine the location of the user computing devices. For example, user computing devices can include a positioning system (e.g., a global positioning system (GPS)). The information that a user computing system obtains from the positioning system can be provided to the computing system 100. The location system 112 can determine, based on data provided by the user computing system, an estimated location for the user computing system.

The location system 112 can estimate the current position of a user computing device that is currently traveling in accordance with navigation instructions provided by the navigation system 114. Based on this information, the location system 112 can predict the time at which a user will complete one or more segments of an overall route. If the route includes a segment that includes an interaction with a system other than the navigation system, the computing system 100 can predict when the interaction needs to occur to allow the user to proceed along their route with minimal delay using information provided by the location system 112. For example, if one segment of the navigation route includes a taxi ride, the location system 112 can provide updated location information to the navigation system, and the navigation system can ensure that the taxi arrives to pick up the user at or before the estimated arrival time.

The computing system 100 can include a navigation system 114. The navigation system 114 can include, but is not limited to, a route generation system 120, an interaction determination system 122, an initiation system 124, and a confirmation system 126. The navigation system 114 can provide route information for users to enable a user to travel from an initial location to an ending location (e.g., a destination). The navigation system 114 can provide, in a display, a visual depiction of a geographic area. The visual depiction of the geographic area can include one or more streets, one or more points of interest (including buildings, landmarks, and so on), and a highlighted depiction of a planned route.

In some examples, the navigation system 114 can receive a navigation query from a user. In some examples, the navigation query can include a destination address. In response, the navigation system 112 can access a geographic data store 234. Using the information in the geographic data store 234, the navigation system 112 can employ the route generation system 120 to determine one or more candidate routes to the destination address.

In some examples, each candidate route generated by the route generation system 120 can include a plurality of segments. Each segment can be associated with a particular mode of transportation. For example, a navigation route can have a walking segment, a driving segment, and a segment traveled using public transportation. In some examples, one or more segments of a candidate route can be provided by a system other than the navigation system. For example, a segment can include a ride on a bus associated with a public transportation system. The interaction determination system 122 can determine, for each segment, whether an interaction with a system other than the navigation system is required and if so, when and how to perform that interaction.

In some examples, the route generation system 120 can rank each of the candidate routes to determine which candidate route to recommend to the user. In addition to other considerations such as cost, time, distance, and so on, the route generation system 120 can rank the candidate routes at least in part based on the interaction with a system other than the navigation system associated with a particular candidate route. The route generation system 120 can determine a user's preferences with respect to external transport systems (transport systems provided by a system other than the navigation system). For example, a user can provide to the navigation system 114 a list of transportation applications installed on their user computing device. A candidate route that includes an interaction with a system other than the navigation system for which the user has already installed an associated application on their user computing device can be ranked higher than a candidate route with an interaction with a system other than the navigation system for which the user has no associated application installed. If a ride-hailing system has an associated computer application that the user has installed on their computing device (e.g., their smartphone), the route generation system 120 can rank candidate routes that include the ride-hailing system more highly than candidate routes that have interactions with other systems other than the navigation system, all other factors being equal.

In some examples, the user can also provide preferences with respect to particular system other than the navigation system or types of transport that can be used to determine how to rank particular candidate routes. For example, a user can routinely use public transportation and make that available to be stored in their user account. As a result, preference data stored in the user account can indicate the user's preference for using public transportation. In another example, a user may indicate a preference for time saved over other factors such that systems other than the navigation system that provide a service associated with a reduction in wait times (e.g., a ride-sharing system), can be ranked more highly than systems other than the navigation system that provide transport that is associated with higher wait times. Similarly, a user can provide their history to the navigation system 114 and the candidate routes can be ranked, at least in part, based on whether the user has previously interacted with a particular system other than the navigation system.

In some examples, the interaction determination system 122 can receive, from the user, account information from the user training the accounting information from a user can include information needed to perform one or more interactions with a system other than the navigation system. For example, if accessing a particular system other than the navigation system is associated with an account number and authentication mechanism (e.g., passcode, password, and so on), the user can provide this information to the interaction determination system 122 to enable the navigation system 114 to perform interactions on behalf of the user.

The interaction determination system 122 can determine, for each potential interaction with a system other than the navigation system, whether the navigation system has the information necessary to perform interactions on behalf of the user. In some examples, the account information can be associated with a payment account. In some examples, the user can, when providing information to the navigation system, instruct the navigation systems to use one or more security preferences or authentication steps when interacting with the respective system other than the navigation system on behalf of the user.

In some examples, the interaction determination system 122 can, based on the route selected by the route generation system 120, transmit a recommendation for display at a user computing device. The recommendation can include a prompt for the user to indicate whether they approve or do not approve of the recommended route, including the interaction with the system other than the navigation system. In some examples, a plurality of route options can be displayed, and the user can select one. In other examples, the user can approve a particular route but disapprove of the interactions with the system other than the navigation system. In response, the navigation system 114 can replace the segment of the route associated with an interaction with a system other than the navigation system with a segment that does not include interaction with a system other than the navigation system.

The interaction determination system 122 can receive a response from the user via a communication from the user computing device. For example, the user can approve of a particular candidate route including a particular interaction with a system other than the navigation system. In response, the interaction determination system 122 can access the initiation system 124 to begin the initiation of the interaction. If the response indicates the user does not wish to perform the interaction for a segment of the candidate route, the interaction determination system can communicate with the route generation system 122 to remove that segment of the route from the candidate route and replace it with another segment.

In some examples, if the user confirms that they wish to perform the interaction necessary for a particular segment of the candidate route, the interaction determination system 122 can determine one or more timing aspects of the interaction. For example, if the interaction involves paying for a ticket to a location that is open all day, the timing at which the ticket is purchased is flexible as long as the ticket is purchased before the user arrives. However, if the interaction includes reserving a taxi or other vehicle to pick up the user at a particular point and at a particular time, the interaction determination system 122 can, based on route information received from the route generation system 120, determine the appropriate time to begin the interaction.

In some examples, the interaction determination system 122 can monitor the current location of the user via location information from the user computing device. When the user reaches a particular portion of the route, the interaction determination system 122 can notify the initiation system 124 that the interaction should be initiated. In this way, for time sensitive interactions, the interaction determination system 122 can ensure that the interaction is initiated at the appropriate time.

In some examples, the interaction determination system 122 can determine, for any segment that includes an interaction with a system other than the navigation system, whether the associated system is available at the requested time. If a particular venue is sold out or there is no room at a particular parking structure, the interaction determination system 122 can notify the right generation system 120 that any candidate route that includes that system other than the navigation system must be discarded and not recommended to the user.

The initiation system 124 can transmit data to the system other than the navigation system to initiate an interaction based on the planned route. In some examples, the initiation system 124 can transmit initiation data directly to the system other than the navigation system via a computer network. A system other than the navigation system can have an API that allows the initiation system to transmit initiation data directly to the system other than the navigation system. The initiation data can be formatted based on the requirements of the API.

In some examples, the initiation system 124 can access the system other than the navigation system via an application installed on the user computing device. For example, instructions can be transmitted to the user computing device to open the target application, perform interactions with the application, and close the application without the need for user intervention. This can be done by controlling the inputs of the user device, with the approval of the user, such that the instructions control the user computing device to simulate the user interacting with the application to accomplish the selected interaction.

In some examples, after the initiation system 124 has transmitted initiation data to the system other than the navigation system, the confirmation system 126 can receive from the system other than the navigation system a confirmation that the interaction has been completed. This confirmation can be transmitted to the user computing device for display. In some examples, the confirmation information will include information about the interaction such as the ticket number, a parking space, or other information needed by the user to successfully perform the interaction. This confirmation information can be transmitted by the confirmation system 126 for display to the user within the navigation system or as is most convenient to the user.

If a segment of a candidate route includes a section on a transport system managed by a system other than the navigation system, the computing system can perform one or more interactions with the system other than the navigation system (e.g., buying tickets, requesting or reserving the transport, and so on). In some examples, the computing system 100 can rank the one or more candidate routes based, at least in part, on the specific system other than the navigation system associated with a respective candidate route in the one or more candidate route.

Once the value guarantee system 122 has determined a specific price for each candidate available time slot, the transmission system 120 can transmit a query response saying that including the one or more available time slots and corresponding prices, to a user computing device. The available time slots and prices can be displayed to the user in the user interface associated with the navigation application. The user can, directly in the interface of the navigation application, select one of the suggested time slots. In response, the user computing device can transmit the user selection data to the computing system 100 and the system can book the user service.

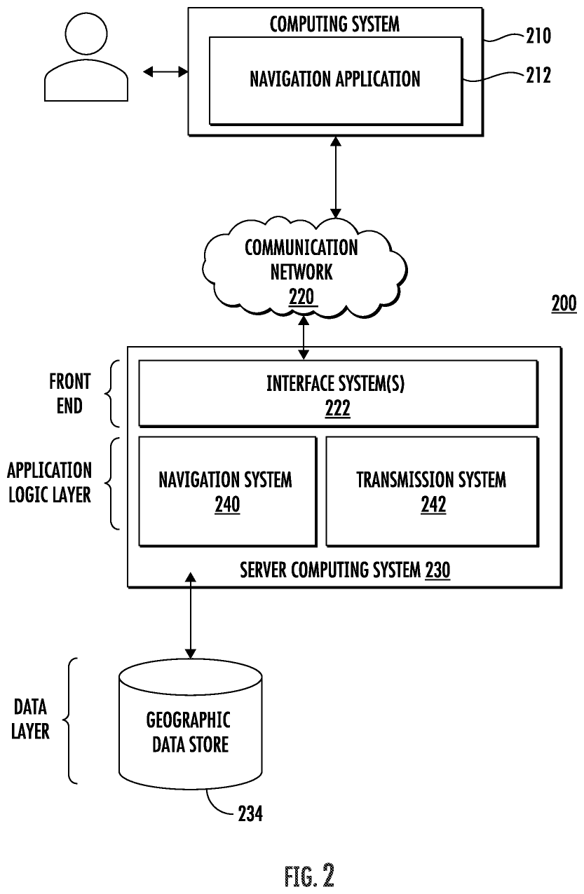

FIG. 2 depicts an example client-server environment 200 according to example embodiments of the present disclosure. The client-server system environment 200 includes one or more user computing systems 210 and a server computing system 230. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks.

A user computing system 210 can include, but is not limited to, smartphones, smartwatches, fitness bands, navigation computing devices, laptop computers, desktop computing systems, and embedded computing devices (computing devices integrated into other objects such as clothing, vehicles, or other objects). In some examples, a user computing system 210 can include one or more sensors intended to gather information with the permission of the user associated with the user computing system 210.

In some examples, the user computing system 210 can connect to another computing device, such as a personal computer (PC), a laptop, a smartphone, a tablet, a mobile phone, an electrical component of a vehicle, or any other electric device capable of communication with the communication network 220. A user computing system 210 can include one or more application(s) such as search applications, communication applications, navigation applications 212, productivity applications, game applications, word processing applications, or any other applications. The application(s) can include a web browser. The user computing system 210 can use a web browser (or other application) to send and receive requests to and from the server computing system 230. The application(s) can include a navigation application 212 that enables the user to send navigation queries to the server computing system 230 and receive query response data in response.

In some examples, the user computing system 210 can include one or more sensors that can be used to determine, with the express permission of the user, information associated with the environment of the user computing system 210 or information associated with the user of the user computing system 210 (such as the position or movement of the user). In some examples, the sensors can include a motion sensor to detect the movement of the device or the associated user, a location sensor (e.g., a GPS) to determine the current location of the user computing system 210, and an audio sensor to gather audio information in the area of the user computing system 210.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more user computing systems 210 and communicates appropriate responses to the user computing systems 210. For example, the interface system(s) 222 may receive requests in the form of Hypertext Transfer Protocol (HTTP) requests, or other web-based, application programming interface (API) requests. The user computing system 210 may be executing conventional web browser applications or applications that have been developed for a specific platform to include any of a wide variety of computing devices and operating systems.

As shown in FIG. 2, the data layer can include a geographic data store 234. The geographic data store 234 can store a variety of navigation data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings, if any, are at that location) can be provided. Similarly, a user can enter the name of a location or point of interest and the system can identify the address associated with that location. In some examples, the geographic data store 234 can include data describing potential interactions with systems other than the navigation system that provide transport services, ticketed events access services, parking services, and so on.

In some examples, the geographic data store 234 can include information that is associated with location determining systems such as the global positioning system (GPS) such that the location of a specific computing device can be determined with respect to the map data. The geographic data store 234 can include direction data that can allow the navigation system 240 to generate routes from an initial location to a particular destination location. In some examples, the geographic data store 234 can include location characteristic information about a plurality of locations or entities. As noted above, the location characteristic information can include the address of the location, the geographic position of the location, the type of the location, the type of entity, the hours of operation of the entity, and so on.

In some examples, the geographic data store 234 can also include image data, the image data associated with one or more geographic areas. The geographic data store 234 can also include satellite image data associated with one or more geographic areas.

The application logic layer can include a navigation system 240 and an interaction system 242. A navigation system 240 can provide, for display, data enabling a visual depiction of a geographic area. The visual depiction of the geographic area can be a map visualization including one or more streets, one or more points of interest (including buildings, landmarks, and so on), and a highlighted depiction of a planned route. The navigation system 240 can receive, via the interface, a navigation query. In some examples, the navigation query can include an initial location and a target destination. The navigation system 240 can generate a plurality of candidate routes from the initial location to the target destination.

In some examples, a respective candidate route in the plurality of candidate routes can include a plurality of segments. Each segment can represent a portion of the total route. In some examples, each segment can employ a different mode of transportation. For example, the first section can include a car ride to the bus station, the second segment can include a ride on a bus provided by a public transportation system, and the third segment can include a walk from the drop off location to the destination.

In some examples, a particular segment can be associated with a method of travel associated with a system other than the navigation system. This system other than the navigation system can be a system that is external to the navigation system. In the above example, one of the segments can be planned to be provided by a public transportation system, which is a system other than the navigation system outside of the navigation system 240. The navigation system 240 can offer to complete one or more interactions with an outside system as part of the right recommendation. For example, the navigation system 240 can purchase a ticket to the bus and transmit the authentication information to the user computing system 210, to enable the user to access the bus without having to leave the navigation application. For example, a visual depiction of a code can represent the payment that is transmitted to the user computing device from the navigation system and can be used to allow the user to scan their way onto the bus.

Thus, the navigation system 240 can select one or more of the candidate routes and transmit the one or more candidate routes to the user computing device for display. If a particular candidate route includes a segment that is associated with interaction with a system other than the navigation system, the user can be prompted to accept or reject the proposed interaction. If the user accepts the proposed interaction, the navigation system 240 can, using interaction system 242, initiate an interaction with a system other than the navigation system.

In some examples, the interaction system 242 can transmit initiation data to a system other than the navigation system. The system other than the navigation system can, in response to the initiation data, perform the requested interaction and transmit a confirmation to the server computing system 230. The confirmation data can include a confirmation code, an image, or other method that can be used to validate the transaction when the user arrives at a particular location in the recommended route. For example, if the confirmation data includes ticket information, a scannable image can be transmitted to the user computing device to be scanned when the user arrives at the location to prove that the user has purchased a ticket.

In some examples, the user can reject the proposed interaction with a system other than the navigation system. In response, the navigation system 240 can generate one or more revised recommended routes. In some examples, the originally recommended route can be revised to remove the segment associated with the system other than the navigation system interaction and replace it with a segment without such interaction.

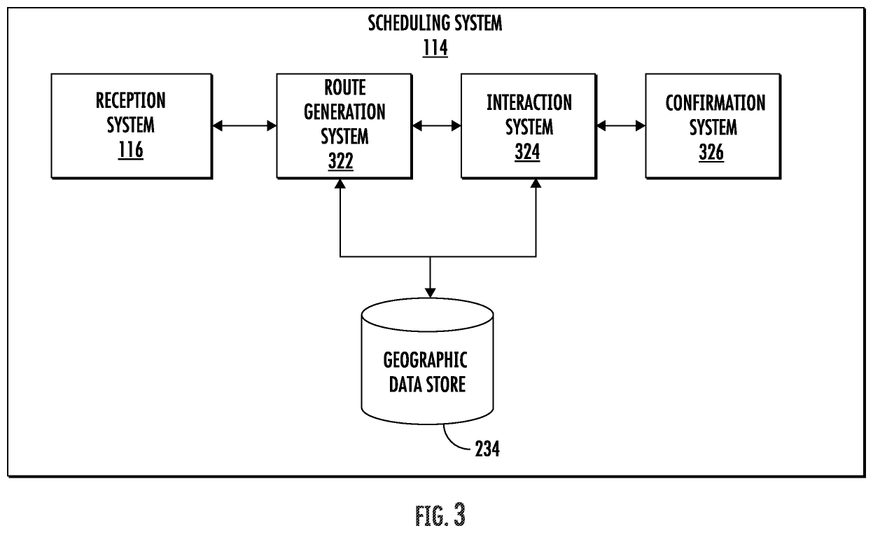

FIG. 3 illustrates an example navigation system 114 in accordance with example embodiments of the present disclosure. The navigation system 114 can include a reception system 116, a route generation system 322, an interaction system 324, and a confirmation system 326.

For example, the reception system 116 can receive a navigation request. In some examples, the navigation request can indicate a particular destination. In other examples, a navigation request can include a query. The query can include one or more search terms that can be matched to one or more entities in the geographic data store 234. In some examples, the query can be a navigational query. The navigation query can also include an origination point. The origination point and the destination point can be transmitted to the route generation system 322.

The route generation system 322 can generate a plurality of candidate routes from the origination point to a destination point. The route can be generated based on the information stored in the geographic data store 234. Each candidate route can include a plurality of segments. Each segment can include a starting point and ending point for the segment. In some examples, each segment can be associated with a different mode of travel. For example, a segment can be associated with a different mode of transportation than the previous segment. For example, a candidate route can include a first segment that includes driving from the initiation point to a location in the downtown of the city. A second segment includes the user parking the vehicle they used to travel the first segment and a third segment that includes walking from the parking location to the destination point.

In some examples, the geographic data store 234 includes data that allows the row generation system 322 planned segments that involve one or more interactions with a system other than the navigation system. For example, the system other than the navigation system can facilitate traveling on one or more modes of travel not associated with the navigation system (e.g., a bus, trade, subway, private taxi, and so on). Thus, one or more segments in a particular kind of route can include traveling via a system other than the navigation system or otherwise interacting with a system other than the navigation system (e.g., buying a ticket, paying for parking, and so on).

In some examples, the route generation system 322 can determine whether a particular interaction is available. For example, if a particular interaction is not available (e.g., due to high demand, etc.) the route generation system 322 can exclude candidate routes that include a segment associated with that interaction from the candidate routes.

In some examples, the right generation system 322 can rank the plurality of candidate routes based on, at least in part, one or more interactions associated with a segment in the candidate routes. In some examples, the user preferences associated with the navigation request are used to determine the rank of the one or more candidate routes.

In some examples, the route generation system 322 selects one or more rounds based on the rankings and transmits them to the user for display or recommendation. The recommended routes can be displayed in the interface associated with the navigation application. In some examples, the recommendation data can include a prompt to approve of interaction with a system other than the navigation system. If the user approves the interaction, the interaction system can initiate the interaction. If the user does not approve, the route generation system can update the exit routes to remove the interaction that the user rejected.

In some examples, the interaction system 324 can initiate an interaction that the user has approved of In some examples, the interaction can be initiated based on timing information associated with the user's location. The interaction system 324 can determine the location of the user and, when the user arrives at a predetermined location, initiate the interaction. For example, if the interaction is summoning a taxi to give the user a ride, the interaction system 324 can estimate the amount of time needed for the taxi to arrive, and initiate calling the taxi such that will arrive at the start of the associated segment at the same time at which the user is estimated to arrive.

In some examples, the interaction system 324 can receive confirmation from the system other than the navigation system that the interaction has been completed. In some examples, the confirmation data can include data associated with the purchase such as a receipt, a ticket, or other proof of purchase. The confirmation system 326 can transmit the proof of purchase or other associated information to the user computing device to enable the user computing device to prove that the purchase has been made when the user arrives at the location. For example, the proof of purchase can include a scannable image that is provided to the user for display on their phone that can be scanned at the point in which the user enters a public transportation system. This kind of image can inform the system that the user has paid and allow them access to the public transportation system. The components of the navigation system 114 can access data within a geographic data store 234.

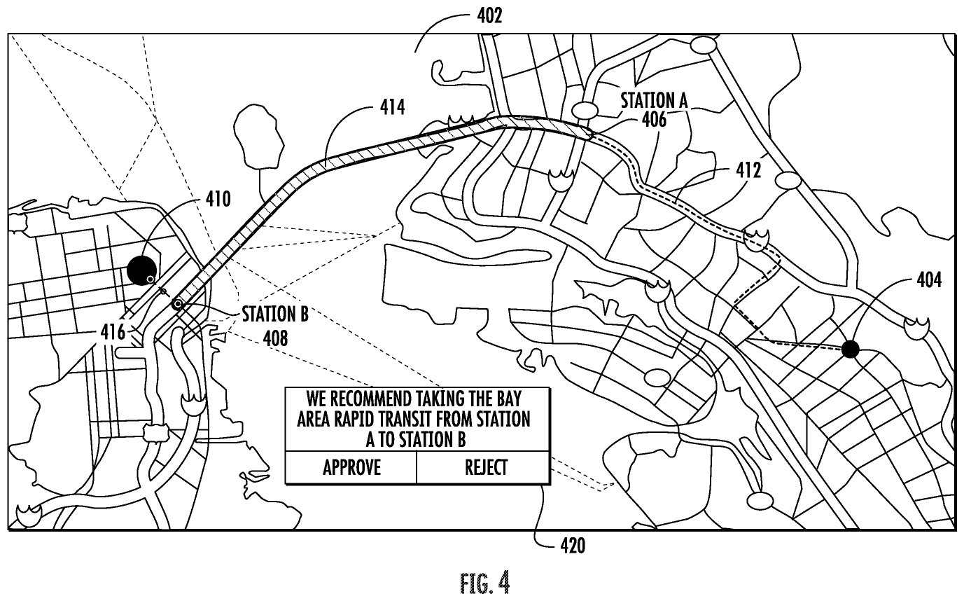

FIG. 4 depicts an example user interface according to example embodiments of the present disclosure. In this example, the user interface can display a geographic map 402 of an area nearby the user computing device. The interface can include a proposed route from an initial position 404 to a destination position 410. The candidate route can include three segments. The first segment 412 can be associated with travel by personal car. The second segment 414 can be associated with travel on a public transportation system. The third segment 416 can be associated with travel on foot.

The interface can include a recommendation 420 that prompts the user to approve or reject a route segment that includes an interaction with a system other than the navigation system. The user can select, via an interaction with the interface (e.g., a click or touch interaction), to either accept the proposed interaction or reject the proposed interaction. In this example, the proposed interaction includes purchasing a ticket to ride the Bay Area Rapid Transit System from a first station to a second station. If the user accepts, corresponding acceptance data can be transmitted to the navigation system. The navigation system can interact with a system other than the navigation system associated with the Bay Area Rapid Transit system to purchase an appropriate ticket.

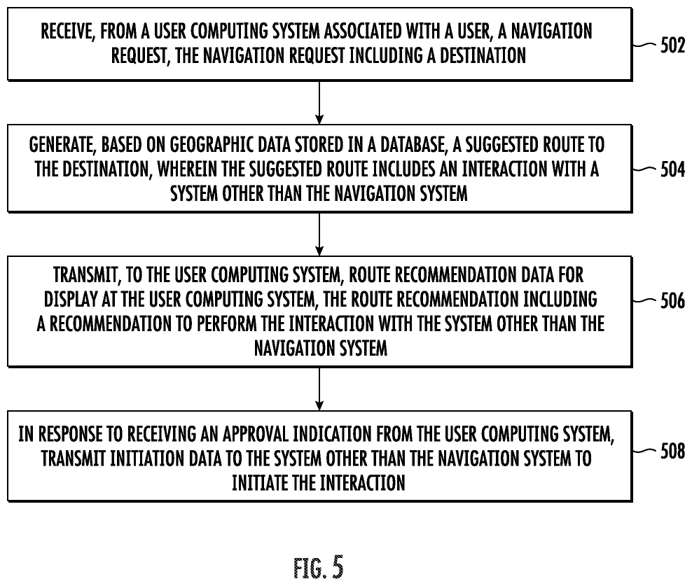

FIG. 5 depicts an example flow diagram for a method for improving a navigation application by incorporating the ability for routes to include interactions with a system other than the navigation system from within the navigation application in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing system (e.g., computing system 100 in FIG. 1) can include one or more processors, memory, and other components that, together, enable the computing system 100 to integrate the use of or integration with one or more systems other than the navigation system into a navigation system. The computing system 100 can, at 502, receive, from a user computing system associated with a user, a navigation request, the navigation request including a destination. In some examples, the computing system can receive, from the user computing system, information describing one or more applications available on the user computing system.

For example, the user computing system can, in response to the user explicitly agreeing to provide information, generate a list of applications currently installed on the user computing system. In some examples, the list can be limited to only those applications that can be associated with particular systems other than the navigation system (e.g., associated with travel and navigation). This information can be used by the navigation system when generating one or more recommended routes such that routes that include interactions with applications already installed on the user computing device can be ranked higher.

In some examples, the user can also provide information about the user's preferences. For example, the user can pre-approve particular systems other than the navigation system which they prefer and/or for which the user has already registered to receive an account number or otherwise interact with the system other than the navigation system. In some examples, the user can provide account information to allow the navigation system to log in to an account associated with a system other than the navigation system on the user's behalf In this way, the interactions can be made directly from the user's account and allow EU interactions to be recorded and or used for rewards or other benefits.

In some examples, the computing system can, at 504, generate, based on geographic data stored in a database, a suggested route to the destination, wherein the suggested route includes an interaction with a system other than the navigation system. In some examples, interactions can include buying tickets, scheduling pick up and drop-offs (e.g., from a taxi service or a ride-hailing system), reserving parking spaces, checking availability, and so on.

In some examples, the recommended route includes a plurality of segments. The interaction can be associated with a respective segment in the plurality of segments. Each segment can have a starting location and an ending location. The ending location of a segment can be the starting location of the following segment. The segments combined represent a route from the initial location of the request to the destination of the request.

In some examples, each segment can have an associated mode of travel. Modes of travel can include personal vehicles, public transportation, walking, cycling, hired taxis, and so on. If a particular segment includes a mode of travel provided by a system other than the navigation system, the computing system can determine whether it is able to perform interactions with the system other than the navigation system. For example, the computing system can determine whether the system other than the navigation system has provided an API that allows interaction requests. The computing system can also determine whether the user computing device includes an application that can perform interaction requests.

In some examples, generating, based on geographic data stored in a database, a suggested route to the destination further comprises the computing system generating, by the computing system, a plurality of candidate routes, wherein one or more respective candidate routes of the plurality of candidate routes include at least one segment that includes an interaction with a system other than the navigation system.

The computing system can select the suggested route based, at least in part, on the interactions associated with the one or more respective candidate routes. Selecting the suggested route can comprise the computing system accessing user preference data associated with the one or more external computing systems. The computing system can rank one or more respective candidate routes based at least in part on the user preference data.

The computing system can, at 506, transmit, to the user computing system, route recommendation data for display at the user computing system. The route recommendation can include a recommendation to perform the interaction with the system other than the navigation system.

For example, a user can transmit a navigation request from their home to a nearby city. The navigation system can generate a route that includes walking to the nearest train station, taking a particular train, and then performing a short walk from the train stop to their destination. The navigation system can transmit the recommended route to the user for display in the navigation application installed on the user computing device. In some examples, the recommendation data also includes a prompt. The prompt can state “do you want the navigation system to purchase a ticket on the train for you?” The user can approve or decline this prompt. In response to approval, the navigation system can interact with the train computing system to purchase a ticket at the appropriate time. Information associated with the purchased ticket can be transmitted to the user computing device for display in the navigation application. In some examples, the confirmation information can include a scannable image that will provide information about the purchased ticket to the train system when the user arrives. In some examples, the navigation system can also prompt the user whether they wish to purchase a return trip ticket.

In another example, the user can submit a navigation request to a particular location. The navigation system can generate one or more recommended routes and determine that for at least one segment of the recommended routes the most effective way to travel is via a personal vehicle. Based on user account data, the navigation system can determine that the user does not have access to (or will not have access to at that point in the route) a personal vehicle. As such, the navigation system can recommend using a taxi or ridesharing service to travel that particular segment of the route. The navigation system can transmit a recommendation to the user including the prompt “Do you want the navigation service to book a taxi to be ready for you when you get off the bus at location A?” If the user provides confirmation (and potential authentication) the navigation system can contact a system other than the navigation system associated with the taxi service to request a taxi at the appropriate place and time. In some examples, the navigation system can wait to request a taxi until the user begins the route and the navigation system is better able to estimate the time at which the user will arrive at the taxi pick-up location. Similarly, the navigation system can deliver the prompt seeking the user approval of the interaction during the navigation session. Thus, a user can begin a route and the navigation system can, when appropriate during the route, prompt the user whether they wish to perform an interaction with the system other than the navigation system (e.g., an external computing system or a third-party computing system). For example, if a first segment of the recommended route includes a long bus ride, the navigation system can send a prompt to the user when the ride has about 30 minutes left, the prompt seeking user approval to arrange a taxi and the end of the bus ride. The user can approve of the taxi or can opt to use a different mode of travel for this second segment.

In some examples, the interaction can be making a reservation and paying for a parking location. Thus, if the user requests navigation directions to a particular place, and the route is intended to be traveled by a personal vehicle, the navigation system can transmit the recommendation to the user as well as a prompt stating “Do you wish the navigation system to reserve and pay for a parking spot for you?” If the user approves, the navigation system can provide a follow-up question requesting the length of stay. Based on this information, and the estimated arrival time, the navigation application can reserve and pay for a particular parking spot and convenient location for the user.

In response to receiving an approval indication from the user computing system, the computer system can transmit initiation data to the system other than the navigation system to initiate the interaction. In some examples, the initiation data can include an interaction request. The interaction request can detail the specific interaction that the computing system seeks to perform (e.g., purchasing tickets, calling a taxi to a particular address, etc.). In some examples, the initiation data can include transaction data to enable the purchase of tickets, etc.

In some examples, the initiation data can be transmitted to the system other than the navigation system using an API associated with the system other than the navigation system. In some examples, the initiation data is transmitted to the system other than the navigation system via an application available on the user computing device.

In some examples, the computing system receives, from the user computing system, user account data provided by the user, wherein the user account data are included in the transaction data. In some examples, the computing system can receive, from the user computing device, audio data recorded from the user. The computing system can authenticate the user's identity based on the audio data.

The computing system can transmit data indicating a completed interaction to the user computing device for display. In some examples, the transmitted data can include a receipt, proof of purchase, or other information that can be used by the user as proof of the transaction when reaching the corresponding segment of the recommended route.

In some examples, the user may reject the recommended interaction. In response to receiving rejection data from the user computing device, the computing system can alter the recommended route to replace the respective segment associated with the interaction with a segment that is not associated with an interaction with a system other than the navigation system.

The technology discussed herein makes reference to sensors, servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for integrating systems other than the navigation system into a navigation system, the method comprising:
receiving, by a computing system with one or more processors from a user computing system associated with a user, a navigation request, the navigation request including a destination;
generating, by the computer system based on geographic data stored in a database, a suggested route to the destination, wherein the suggested route includes an interaction with a system other than the navigation system;
transmitting, by the computing system to the user computing system, route recommendation data for display at the user computing system, the route recommendation including a recommendation to perform the interaction with the system other than the navigation system; and
in response to receiving an approval indication from the user computing system, transmitting, by the computing system, initiation data to the system other than the navigation system to initiate the interaction.

2. The computer-implemented method of claim 1, wherein the initiation data includes transaction data.

3. The computer-implemented method of claim 2, further comprising:
receiving, by the computing system from the user computing system, user account data provided by the user, wherein the user account data are included in the transaction data.

4. The computer-implemented method of claim 1, further comprising:
receiving, by the computing system from the user computing device, audio data recorded from the user; and
authenticating, by the computing system, the user based on the audio data.

5. The computer-implemented method of claim 1, further comprising:
transmitting, by the computing system, data indicating a completed interaction to the user computing device for display.

6. The computer-implemented method of claim 1, wherein the recommended route includes a plurality of segments.

7. The computer-implemented method of claim 6, wherein the interaction is associated with a respective segment in the plurality of segments.

8. The computer-implemented method of claim 7, further comprising:
in response to receiving rejection data from the user computing device, altering, by the computing system, the recommended route to replace the respective segment associated with the interaction with a segment that is not associated with an interaction with a system other than the navigation system.

9. The computer-implemented method of claim 1, wherein generating, by the computer system based on geographic data stored in a database, a suggested route to the destination further comprises:
generating, by the computing system, a plurality of candidate routes, wherein one or more respective candidate routes of the plurality of candidate routes include at least one segment that includes an interaction with a system other than the navigation system; and
selecting, by the computing system, the suggested route based, at least in part, on the interactions associated with the one or more respective candidate routes.

10. The computer-implemented method of claim 1 wherein selecting, by the computing system, the suggested route based, at least in part, on the interactions associated with the one or more respective candidate routes further comprises:
accessing, by the computing system, user preference data associated with the one or more external computing system; and
ranking, by the computing system, one or more respective candidate routes based at least in part on the user preference data.

11. The computer-implemented method of claim 1, wherein the initiation data is transmitted to the system other than the navigation system using an API associated with the system other than the navigation system.

12. The computer-implemented method of claim 1, further comprising:
receiving, from the user computing system, information describing one or more applications available on the user computing system.

13. The computer-implemented method of claim 11, wherein the initiation data is transmitted to the system other than the navigation system via an application available on the user computing device.

14. The computer-implemented method of claim 1, wherein the system other than the navigation system is a third-party system

15. A computing device, the computing device comprising:
one or more processors; and
a computer-readable memory, wherein the computer-readable memory stores instructions that, when executed by the one or more processors, cause the computing device to perform operations, the operations comprising:
receiving, from a user computing system associated with a user, a navigation request, the navigation request including a destination:
generating, based on geographic data stored in a database, a suggested route to the destination, wherein the suggested route includes an interaction with a system other than the navigation system;
transmitting, to the user computing system, route recommendation data for display at the user computing system, the route recommendation including a recommendation to perform the interaction with the system other than the navigation system; and
in response to receiving an approval indication from the user computing system, transmitting initiation data to the system other than the navigation system to initiate the interaction.

16. A non-transitory computer-readable storage medium storing instructions that, when executed by one or more computing devices, cause the one or more computing devices to perform operations, the operations comprising:
receiving, from a user computing system associated with a user, a navigation request, the navigation request including a destination:
generating, based on geographic data stored in a database, a suggested route to the destination, wherein the suggested route includes an interaction with a system other than the navigation system:
transmitting, to the user computing system, route recommendation data for display at the user computing system, the route recommendation including a recommendation to perform the interaction with the system other than the navigation system; and
in response to receiving an approval indication from the user computing system, transmitting initiation data to the system other than the navigation system to initiate the interaction.

17. The non-transitory computer-readable storage medium of claim 16, wherein the initiation data includes transaction data.

18. The non-transitory computer-readable storage medium of claim 17, the operations further comprising:
receiving, from the user computing system, user account data provided by the user, wherein the user account data are included in the transaction data.

19. The non-transitory computer-readable storage medium of claim 16, the operations further comprising:
receiving, from the user computing device, audio data recorded from the user; and
authenticating the user based on the audio data.

20. The non-transitory computer-readable storage medium of claim 16, the operations further comprising:
transmitting data indicating a completed interaction to the user computing device for display.
